(19) United States
(12) Patent Application Publication
(10) Pub. No.: US 2006/0190630 A1
(43) Pub. Date: Aug. 24, 2006

(54) Apparatus and method to pass through data in a storage area network

(75) Inventor: Miklos Sandorfi, Northborough, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: SEPATON INC., MARLBOROUGH, MA (US)

(21) Appl. No.: 10/546,545

(22) PCT Filed: Feb. 25, 2004
(86) PCT No.: PCT/US04/05579

§ 371 Date: Aug. 23, 2005

Related U.S. Application Data
(60) Provisional application No. 60/450,020, filed on Feb. 25, 2003.

(51) Int. Cl. G06F 3/00

(52) U.S. Cl. 710/5

(57) ABSTRACT

An auxiliary controller is interposable intermediate a data source (such as one or more computers or one or more mass storage devices) and a data sink (such as one or more mass storage devices or one or more computers) to provide additional operations on s the data as desired without interfering with the transmission of data between the source and sink.

### CROSS-REFERENCE TO RELATED APPLICATIONS

The present application claims the benefit of U.S. Provisional Patent Application Ser. No. 60/450,020, which was filed on Feb. 25, 2003, by Miklos Sandorfi for Apparatus and Method To Pass Through Data In A Storage Area Network and is hereby incorporated by reference.

### BACKGROUND OF THE INVENTION

1. Field of the Invention

The invention relates to storage controllers for mass storage devices.

2. Background Information

Computer systems typically include one or more mass storage devices such as tape and disk drives for storing large amounts of data. Typically, once such systems are configured, it is difficult to change their capabilities without significant interruption to their operation.

### SUMMARY OF THE INVENTION

An auxiliary controller is interposable intermediate a data source (such as one or more computers or one or more mass storage devices) and a data sink (such as one or more mass storage devices or one or more computers) to provide additional operations on the data as desired without interfering with the transmission of data between the source and sink.

### BRIEF DESCRIPTION OF THE DRAWINGS

The invention description below refers to the accompanying drawings, of which:

FIG. 1 is a block diagram of a data management unit in accordance with the present invention.

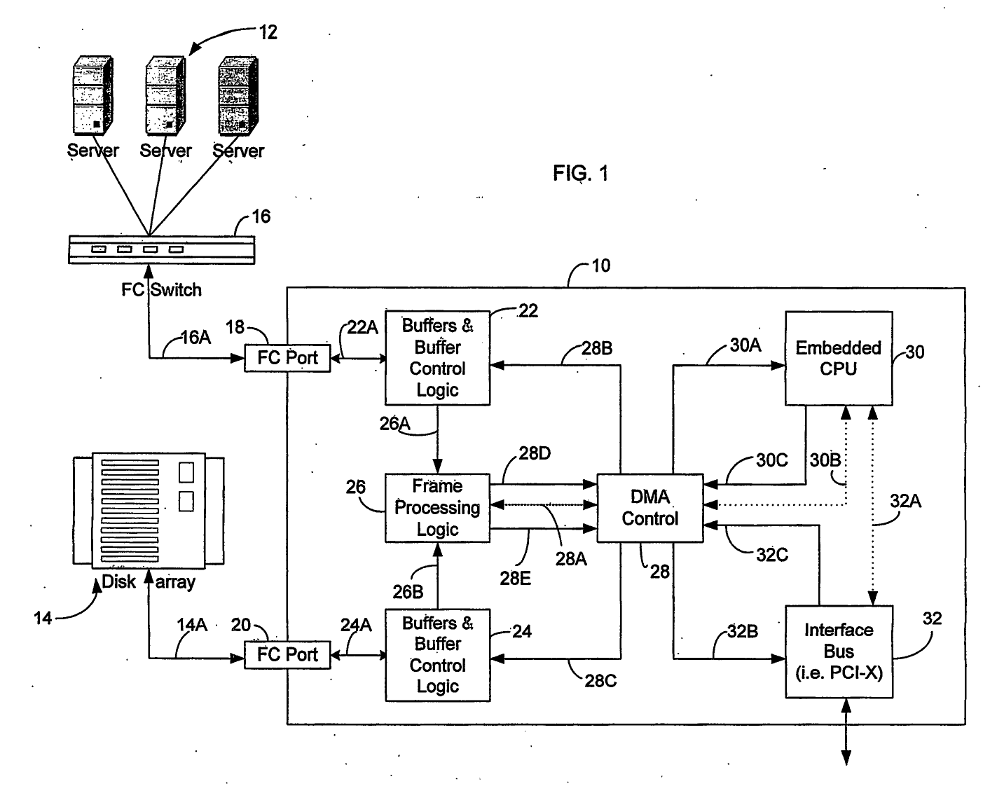

### DETAILED DESCRIPTION OF AN ILLUSTRATIVE EMBODIMENT

A data management unit 10 is interposed between one or more servers 12 and one or more disk storage systems shown, for purposes of illustration, as a disk array 14, by means of a switch 16, preferably a fibre channel switch. The unit 10 has a port 18 through which data flows to and from the switch 16 via a data path 16a, and a port 20 through which data flows to and from the disk array 14 via a data path 14a. The ports 18 and 20 preferably are fibre channel compliant ports. Buffers and buffer control logic units 22, 24 receive and transmit fibre channel primitive signals and frames via data paths 22a and 24a, respectively, and enforce fibre channel framing and transmission rules.

Frame processing logic 26 is connected to receive data from the buffers and buffer control logic units 22, 24 via data paths 26a and 26b, respectively. The unit 26 is capable of making routing decisions on a frame by frame basis based on the data within the frame, whether control data, user data, primitives, etc. These decisions can be based, for example, on a frame's source ID, its destination ID, on other components of the header, on optional headers, on included command descriptor blocks, or other data associated with or contained in the frame.

As described in more detail momentarily, a Direct Memory Access (DMA) control unit 28 assists in the transport of frame data through the data management unit 10. Unit 28 exchanges control signals with frame processing logic unit 26 via a control data path 28a; passes data to buffers and buffer control logic units 22 and 24 via data paths 28b and 28c, respectively; and receives data from frame processing logic unit 26 via data paths 28d and 28e, respectively.

An embedded Central Processing Unit (CPU) or computer 30 receives data from DMA control unit 28 via a data path 30a, exchanges control signals with the unit 28 via a control data path 30b, and provides data as required to unit 28 via a data path 30c. CPU 30 is programmable to perform operations on, or responsive to, the data being transmitted between servers 12 and disk array 14. The program may be fixed in CPU 30 or alterable so that new capabilities may be provided to the data management unit 10 simply by altering the programs in the CPU 30.

An interface bus unit 32, preferably a standard bus unit such a Peripheral Component Interconnect-X (PCI-X) unit, enables data transport between the unit 10 and components outside the unit. Unit 32 exchanges control signals with CPU 30 via a control data path 32a, receives data from DMA control unit 28 via a data path 32b, and provides data to unit 28 via a data path 32c.

The data management unit 10 is capable of operating in a number of different modes on data passing through it. These modes may be determined by the frame processing logic unit 26, the CPU 30, or both in combination, and may be set either independent of the data passing through the unit 10 or dependent on such data. However, most commonly the operating mode of the unit 10 will be established based on the data passing through the unit and in accordance with predefined selection criteria. Further, the mode may be set on a frame by frame basis and in accordance with data contained in more or more fields of the frame, so that successive frames may be processed in the same manner or may be processed in entirely different ways. Examples of this will now be given.

A first exemplary operating mode is a “pass-through” mode in which data streams are passed from a data source such as the array 12 and a data sink such as the array 14, or in the reverse direction. In the forward direction, data flows from one or more of the servers 12 through the fibre channel switch 16 and the port 18 into the logic unit 22 and thence via data path 26a into the frame processing logic unit 26. The latter typically examines data in the frames in order to determine what operations, if any, are to be performed on them. In the case of data frames that are to be passed through the unit 10 without alteration, the frames are accordingly transmitted over data path 28d to control unit 28, and thence via data path 28c to control logic unit 24. From the latter they are passed via data path 14a to disk array 14.

As indicated above, the pass-through mode may also operate to transmit data in the reverse direction, i.e., from disk array 14 to server array 12. In this case, the data flows from the array 14 via data path 14a into fibre channel port 20 and thence via data path 24a into control logic unit 24. From thence it is passed via data path 26b into frame processing logic unit 26 and thence forwarded without alteration over data path 28e to DMA control unit 28. From the latter, it passes over data path 28b to control logic unit 22 and thence to FC pert 18 via data path 22a. From port 18, the data is transmitted via data path 16a to switch 16 and thence to the array 12. Regardless of the direction in which it is passed, the data is passed through the unit 10 without alteration in the pass-through mode, and neither the server array 12 nor the disk array 14 see any change in their operations.

A second operating mode is a “watch” mode in which data passing between the arrays 12 and 14 in either direction is monitored. The data flows over the same paths as described for the “pass-through” mode but, additionally, responsive to specific data found in one or more frames, the frame processing logic 26 communicates with the CPU, and vice versa, via control data paths 28a and 30b and DMA control unit 28. For example, the CPU may maintain a log of certain patterns found in the frames as they pass through the frame processing logic units 26. Once the CPU has made the desired record, it notifies the frame processing logic unit 26 via control signals sent over the control data path 30b, DMA control unit 28, and control data path 28a. The logic unit 26 then releases the frame as to which a record has been made and passes over data path 28d into DMA control unit 28, thence via data path 28b, control logic unit 22, data path 22a, port 18, data path 16a and switch 16 into the array 12. Again, neither the server array 12 nor the disk array 14 see any change in their operations.

A third mode of operation for the unit 10 is the “clone” or “copy” mode. In this mode, the transmission of data between the data source and data sink (e.g., between the arrays 12 and 14) is the same as in the pass-through mode but, additionally, a copy of the data is provided to the interface bus 32 for transmission to a selected device exterior to the unit 10. The copy may be responsive to the contents of a particular frame or determined independently of the contents, as may be defined in a particular case by the frame processing logic unit 26 and/or CPU 30.

Thus, when it is determined that a particular frame, or sequence of frames, is to be copied, at the time the frame or frames in question are passed from the logic unit 26 to the DMA unit 28 for transmission to the disk array 14 via the data path 28c or to the server array 12 via the data path 28b, a copy of the frame or frames in question is also sent from the DMA unit 28 via the data path 32b to the interface bus 32 from which it is transmitted to a designated component or destination. For example, this mode may be used to backup data selectively or entirely. Despite the copy operation, however, neither the server array 12 nor the disk array 14 see any change in their operations, i.e., they are unaware that a copy has been made or that the data has been passed through the unit 10.

A further mode of operation is the “branch” or “data modification” mode. In this mode, one or more frames passing between the data source and sink are selected for modification. As discussed above, the selection may be responsive to the contents of a particular frame or determined independently of the contents, as may be defined in a particular case by the frame processing logic unit 26 and/or CPU 30. In this mode, when a frame that is to be modified is in the logic unit 26, it is not immediately forwarded to the data path 28c in the case of a data transfer from array 12 to array 14, or to data path 28b in the case of a transfer in the reverse direction. Instead, logic unit 26 signals control unit 26 that processing is required, and transfers the frame to DMA control unit 28. The latter then transmits it via data path 30a to CPU 30 for processing. On completion of processing, the CPU 30 signals the DMA control unit 28 via control data path 30b and returns the processed (usually modified) data to the unit 28. The latter then forwards it in the direction in which it was originally headed, i.e., to the array 14 via data path 28c or to the array 12 via the data path 28b. As was previously the case, neither the server array 12 nor the disk array 14 see any change in their operations, i.e., they are unaware that the data has been modified or that the data has been passed through the unit 10.

As noted above, the processing mode for each frame may be independent of the contents of the frame of may be dependent on finding certain patterns or content in such portions of the frame as its source ID, its destination ID, on other components of the header, on optional headers, on included command descriptor blocks, or other data associated with or contained in the frame. A broad choice of processing selections may thus be made for data passing through the data management unit. For example, data frames destined for a particular device or associated with a particular file may be copied or modified without affecting other frames in the data stream passing through the data management unit.

From the foregoing it will be seen that there is provided a data management unit which can readily be interposed between a data source and a data sink without significantly interrupting the transfer of data between the two but which can significantly ex-tend the capabilities of a system in which it is incorporated. The unit is a free-standing unit, and is preferably formed on a single chip.

A variety of other applications and modes may readily be implemented with the structure described herein and it is intended that the foregoing be taken as illustrative is only, and not in a limiting sense.

What is claimed is:

1. A data management unit interposable between a source and a sink of data and providing access to such data for possible operations thereon, comprising:
a logic unit for examining data as it passes between said source and said sink;
a control unit including at least a central processing unit for controlling operations on at least a portion of said data, said operations including at least any of (1) copying said data as it passes through said unit and (2) modifying said data, as it passes through said unit, said unit operating on said data without communication with either said source or said sink.

2. A data management unit according to claim 1 in which the operations to be performed on said data are determined from examining the data itself.

3. A data management unit according to claim 1 in which the operations to be performed on said data are determined independently of said data.

4. A data management unit according to claim 1 in which said data is segmented into frames and in which operations are performable on a frame-by-frame basis.

5. A data management unit interposable between a source and a sink of framed data and providing access to such data for possible operations thereon on a frame-by-frame basis, comprising:
a logic unit for examining each data frame as it passes between said source and said sink;
a control unit responsive to detecting a defined pattern in a data frame to enable an operation to be performed on said data, said operation including at least one of (1) copying said data as it passes through said unit and (2) modifying said data as it passes through said unit, said unit operating on said data without communication with either said source or said sink.

6. A data management unit according to claim 5 in which said control unit enables both said operations to be performed on said data as it passes through the data management unit.

7. A data management unit according to claim 5 in which said control unit is further capable of enabling said data to pass through said data management unit without performance of any operations thereon.

8. A data management unit according to claim 5 in which said control unit includes a frame processing logic unit for examining the contents of said frames for defined patterns therein and a central processing unit cooperating with said frame processing logic unit and responsive to detection of a defined pattern in a frame to control processing of said frame.

9. A data management unit according to claim 5 in which, responsive to a selected defined pattern in a data frame, said central processing unit creates a record indicating detection of said pattern.

10. A data management unit according to claim 5 which further includes an interface bus for passing copied data to an device external to the data management unit.

11. A data management unit according to either of claims 5 or 9 which further includes fibre channel input and output ports for passing data conforming to a fibre channel protocol.
